(19) United States
(12) Patent Application Publication
(10) Pub. No.: US 2012/0124057 A1
(43) Pub. Date: May 17, 2012

(54) EXTERNAL USER IDENTIFICATION AND VERIFICATION USING REPUTATION DATA

(75) Inventors: Wisam G. Daoud, San Mateo, CA (US); Sarika Krishnan, San Jose, CA (US); Rishikesh Tembe, San Francisco, CA (US)

(73) Assignee: eBay Inc., San Jose, CA (US)

(21) Appl. No.: 12/945,596

(22) Filed: Nov. 12, 2010

(51) Int. Cl. G06F 17/30

(52) U.S. Cl. 707/748; 707/E17.005

(57) ABSTRACT

In a system and method for user identification and verification using reputation data, a processor-implemented feedback component receives feedback data pertaining to a user of a network-based community in response to a transaction in which the user is a party. A processor-implemented tracking component tracks transaction data and metadata associated with the transaction data and the feedback data. A processor-implemented aggregation component aggregates the received feedback data and the tracked data and metadata to yield an aggregated set of data pertaining to the user. A processor-implemented reputation component generates a reputation value for the user from the aggregated set of data. If the reputation value is greater than a predetermined threshold value, the user is considered trustworthy, and if the reputation value is not greater than the predetermined threshold value, the user is not considered trustworthy.

### TECHNICAL FIELD

This application relates to a method and system for identifying and verifying users using reputational data.

### BACKGROUND

As online applications mature, users and merchants increasingly communicate and participate in a variety of transactions and commerce with each other. Buyers and sellers (e.g., individuals and merchants) transact with each other based on good faith and whatever knowledge they may have about each other as transacting parties and/or members of the transacting community. However, as in any community, the trustworthiness and reliability of buyers and sellers will vary. The ability to ascertain these and other reputational qualities of a party to a transaction is one hurdle to overcome for improving transaction experiences.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2A is a block diagram illustrating an example embodiment of multiple publication applications, which may be provided as part of a network-based publisher;

FIG. 2B is a block diagram illustrating an example embodiment of various modules that may used to execute the processes described herein;

FIG. 3 is a flow chart 300 of an example method for tracking, aggregating, and providing user reputation data.

FIG. 4 is a flow chart 400 of an example method for determining and providing a trustworthiness determination of a user.

FIG. 5 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In various embodiments, a system and method to identify and verify a user of a network-based community using reputation data is disclosed. Reputation data may take the form of feedback data received in response to a transaction as well as tracked transaction data and metadata associated with both transactions and feedback. The reputation data may be aggregated to provide a comprehensive view of a user, as perceived by the network-based community. A reputation value is generated using some or all of the aggregated data, and a trustworthiness of the user is determined by comparing the reputation value to a predetermined threshold value. The user may be considered trustworthy if the user's reputation value is greater than the threshold value.

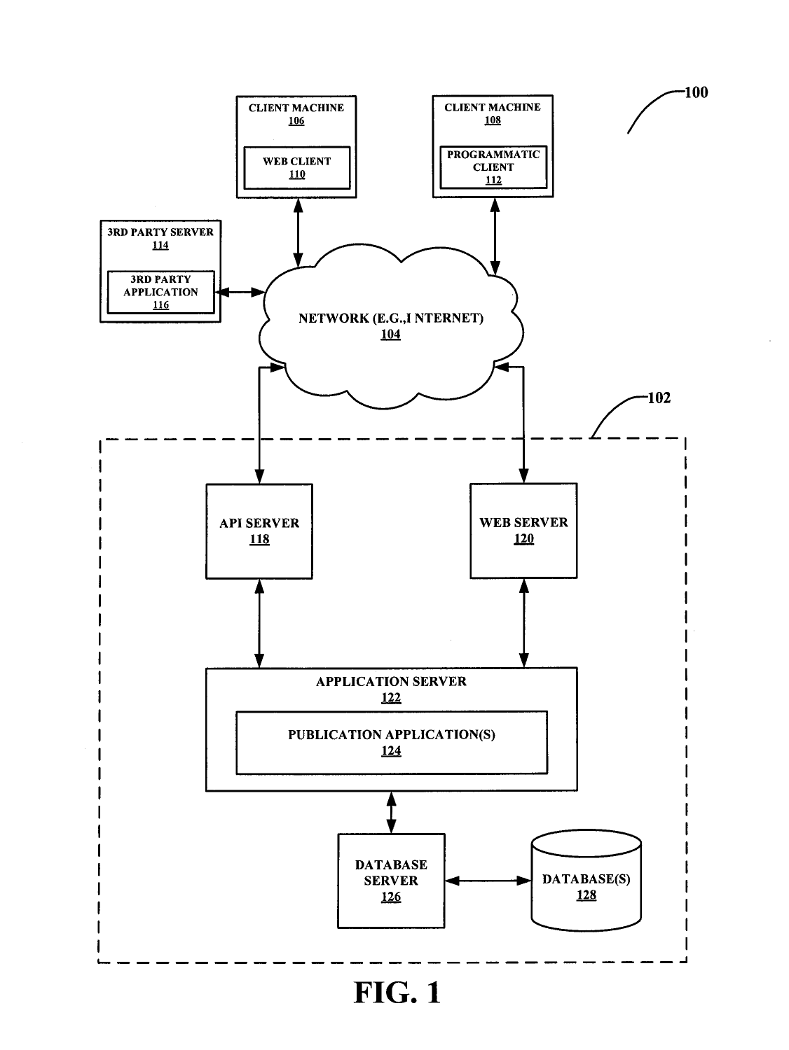

FIG. 1 is a network diagram depicting a network system 100, according to one embodiment, having a client-server architecture configured for exchanging data over a network. For example, the network system 100 may be a publication/publisher system 102 where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a network-based publisher 102, may provide server-side functionality, via a network 104 (e.g., the Internet) to one or more clients. The one or more clients may include users that utilize the network system 100 and more specifically, the network-based publisher 102, to exchange data over the network 114. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party application 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

Turning specifically to the network-based publisher 102, an application program interface (API) server 118 and a web server 120 are coupled to, and provide programmatic and web interfaces respectively to, one or more application servers 122. The application servers 122 host one or more publication application (s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., client application 112 or third party application 116) running on another client machine (e.g., client machine 108 or third party server 114).

The publication application(s) 124 may provide a number of publisher functions and services (e.g., listing, payment, etc.) to users that access the network-based publisher 102. For example, the publication application(s) 124 may provide a number of services and functions to users for listing goods and/or services for sale, facilitating transactions, and reviewing and providing feedback about transactions and associated users. Additionally, the publication application(s) 124 may track and store data and metadata relating to listings, transactions, and user interaction with the network-based publisher 102. The publication application(s) 124 may aggregate the feedback and/or the tracked data and metadata to enable a user to collectively view accumulated feedback and/or tracked data. In one example embodiment, from the aggregated data, the publication application(s) 124 may determine a reputation, for example, in the form of a score or value, for one or more users of a network-based community, the reputation value being based on one or more user attributes associated with the one or more users.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

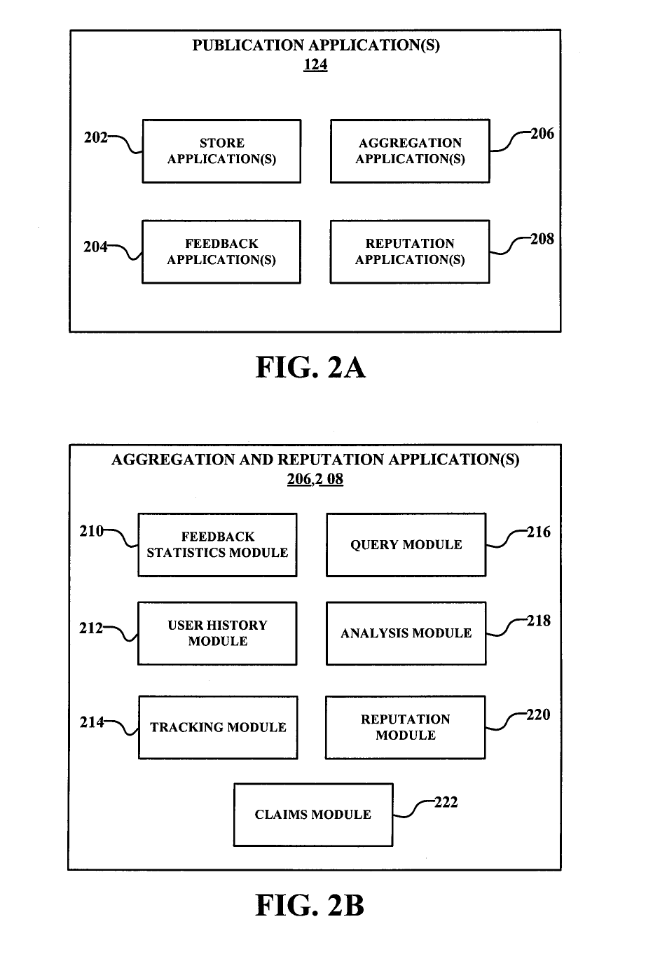

FIG. 2A is a block diagram illustrating an example embodiment of multiple publication application(s) 124, which are provided as part of the network-based publisher 102. The network-based publisher 102 may provide a multitude of feedback, reputation, aggregation, and listing and price-setting mechanisms whereby a user may be a seller or buyer who lists or buys goods and/or services (e.g., for sale) published on the network-based publisher 102.

The publication application(s) 124 are shown to include, among other things, one or more application(s) which support the network-based publisher 102, and more specifically, the listing of goods and/or services for sale, the receipt of feedback in response to a transaction involving a listing, the tracking of data and metadata relating to the listings and user interactions with the network-based publisher 102, the aggregation of feedback and tracked data, and the generation of reputation values for users based on the aggregated data.

Store application(s) 202 permit sellers to list individual goods and/or services (hereinafter generically referred to as “items”) for sale via the network-based publisher or group their listings within a “virtual” store, which may be branded and otherwise personalized by and for the sellers. Individual and grouped listings may include details such as a title of an item offered for sale, a description of the item, a price of the item, one or more pictures of the item, a geographic location of the seller or the item, payment and shipping options, and a return policy. The virtual store also may offer promotions, incentives and features that are specific and personalized to a relevant seller. In one embodiment, a seller using a virtual store to sell their goods and services may result in the network-based publisher 102 determining a higher reputation value because of an inherent trustworthiness (e.g., higher reputation value) of a “business” over an individual seller.

Feedback application(s) 204 may allow parties that transact using the network-based publisher 102 to establish, build, and maintain buyer or seller reputations, which may be made available and published to potential trading partners (e.g., users of the network-based publisher 102). Consider, for example, where the network-based publisher 102 supports person-to-person trading, users may have no history or other reference information whereby the trustworthiness and/or credibility of potential trading partners may be assessed. The feedback application(s) 204 may allow a first user, for example through feedback provided by other users, to establish a buyer/seller reputation within the network-based publisher 112 over time and transactions. Thus, other potential transaction partners (users) may then reference the buyer/seller reputation value of the user for the purpose of assessing credibility, trustworthiness, etc.

Feedback may be received in the form of answers to a series of questions concerning topics such as satisfaction with a transaction, speed in concluding a transaction, and promptness of payment or shipping. Feedback additionally may be received in the form of comments input by a counterparty to the transaction. Both types of feedback may be viewed by the user to whom they are directed and other parties who access a profile of the user, and may be segregated on a per transaction basis. Conventionally, feedback is limited to the answers and comments provided by a counterparty, thereby providing a user with only a limited perspective of how the user has performed or how the user is perceived by others in the network-based community.

Aggregation application(s) 206 may aggregate feedback received for a user by the feedback application(s) 204. The aggregated feedback may provide the user with a view of the collective feedback left for the user. In one example embodiment, the aggregated feedback may be provided anonymously such that the user is unable to see the identity of the party leaving the feedback. Anonymous presentation of feedback may require that a certain number of feedback responses be received, to prevent the user from being able to associate anonymous feedback responses with the sender of the feedback. The aggregated feedback may be analyzed and filtered (e.g., sub-divided by one or more dimensions, such as by one or more parameters, user attributes, or metrics) to provide the user with one or more views of the aggregated feedback. The dimensions may be determined using metadata associated with the feedback.

Aggregation application(s) 206 further may aggregate tracked data and metadata relating to a user's listings, if the user is a seller, transactions, and interactions with the network-based publisher. Aggregation application(s) 206 further may aggregate the tracked data and metadata with the received feedback to provide a user with a comprehensive overview of the user's attributes, as perceived by other parties.

Reputation application(s) 208 may operate on the received feedback, the tracked data and metadata, or the aggregation of feedback and tracked data to determine a user's reputation. It can be appreciated by one skilled in the art that users may have a multitude of various types of reputation values in the network-based publisher 102. For example, a user may have a reputation value for being a buyer and one as a seller. The user's reputation value may be based on one or more user attributes determined from feedback or tracked data or metadata. The user attributes may include, but are not limited to, feedback ratings, the user's frequency of interaction with the network-based publisher 102, the number of items a user has sold, the promptness of the user in concluding a transaction or shipping an item, the length of time a user has been using the network-based publisher 102, and a category of transaction including a user's expertise (e.g., power seller) in a category. Some or all of these attributes may have values or weights assigned to them that may be used in conjunction with other values and factors to determine a reputation value of a user.

Reputation application(s) 208 further may provide user reputation data to third party applications through an exposed application programming interface (API). In this respect, third party applications may query the network-based publisher 102 for a trustworthiness determination for a user of the third party system, who may or may not also be a user of the network-based community 100. If the user is part of the network-based community 100, reputation application(s) 208 may retrieve and provide the user's reputation value to the third party system, or may make a determination of trustworthiness and provide the determination to the third party system.

FIG. 2B is a block diagram illustrating an example embodiment of a feedback statistics module 210, a user history module 212, a tracking module 212, and a reputation module 214, which may be utilized by the aggregation application(s) 206 and the reputation application(s) 208 to aggregate user attributes and determine a reputation of the user.

In one embodiment, the feedback statistics module 210 may operate in conjunction with the feedback application 204 to analyze the feedback received for a particular user. Receive feedback data may comprise user-selected answers to questions posed by the network-based publisher 102 as well as free form comments inputted by transaction counterparties to the user. The feedback statistics module 210 may access the received feedback, analyze the feedback or feedback metadata to generate statistical information about the received feedback, and identify trends, patterns, anomalies, or other meaningful statistics. The feedback metadata may comprise descriptive or identifying data about the feedback or the user leaving the feedback. This metadata may include, but is not limited to, the date and time the feedback is inputted; identifying details about the user inputting the feedback, such as that user's own reputation, location, and history; and the category of the item for which feedback is being received.

In one example embodiment, if one hundred feedback responses have been received for a particular user, the feedback statistics module 210 may access the feedback responses and identify that feedback received from users in a particular geographic region to which an item is shipped is negative, while feedback received from all other geographic regions to which other items are shipped is positive. This identification may be obtained by mining the text of feedback responses submitted by buyers to identify an area of need in which a seller should be alerted. This analysis would show that a user, such as a seller, perhaps is having difficulty shipping an item to that geographic region. In another example embodiment, the feedback statistics module 210 may analyze the same one hundred feedback responses and determine that a user is receiving better feedback for a particular category of item relative to other item categories. This analysis may inform the user that the user needs to improve his handling of the other item categories, or that the user should focus on listing only items in the category in which he is receiving better feedback.

The user history module 212 may interface with the database server 126 of the network-based publisher 102 to access user history profiles stored in database(s) 128. User history profiles may store historical data on user activity and interaction with the network-based profile. This historical data may include, but are not limited to, transactions involving the user, frequency of interaction with the network-based publisher, archived data, such as archived feedback data, items listed for sale, and items browsed for purchase. The historical data further may be grouped or searched over various time periods. The user history module 212 may make the historical user data available to the other modules and applications of the network-based publisher 102 for use in aggregating user attribute data and determining a user reputation, for example, in the form of a score or value.

The tracking module 214 may track and store both network-based publisher data, such as data concerning users and transactions, and metadata associated with the network-based publisher data. Metadata may include, but are not limited to, the date and time of various interaction events between a user and the network-based publisher 102, location data, such as a user location, an item location, shipping origination and destination points, the categories of items offered for sale or purchased, and the feedback ratings or reputations of counterparties to a particular user (e.g., buyer ratings if the user is a seller). Both tracked data and metadata may be made available for other applications and modules. For example, the aggregation application(s) 206 may include the tracked data and metadata in the data to be aggregated and analyzed.

When aggregated, the tracked data and metadata provides the user with a more comprehensive view of the user's attributes, as perceived by the network-based publisher 102. The aggregated data further may be sliced or isolated by metric or user attribute, such that the user is provided with one or more dimensions in which to view and analyze the data.

A query module 216 may receive user queries to view or access the aggregated data. The query module 216 may determine the type of query submitted by the user and may parse the query to extract search terms or categories. One type of query may be a user attribute query in which the user desires to view data containing a certain user attribute. For example, the user may wish to see data concerning all transactions involving a particular type of item. A second type of query may be a contextual category query in which the user desires to view all data pertaining to a particular category. The contextual category query differs from the user attribute query in that data spanning multiple user attributes may be grouped together in an overarching category. Categories may be dynamically created and defined by the user based on one or more pieces of tracked metadata.

An analysis module 218 may receive parsed user queries and may search the aggregated set of data using the parsed search terms to retrieve relevant and responsive data. The analysis module 218 further may be responsible for grouping or categorizing aggregated data in response to a contextual category query. The analysis module 218 may present the relevant data to the user as a set of search results.

Using aggregated data and metadata for a particular user, the reputation module 220 may determine a reputation for the user. In one example embodiment, the reputation may take the form of a score or a value. In a further exemplary embodiment, each user may have multiple reputational scores or values corresponding to the user's role as a seller or a buyer, or corresponding to the user's role as a seller of a first category of items compared to a seller of a second category of items.

The reputation for a user may be generated or calculated based on user attributes included in the aggregated data. Different pieces of aggregated data may be assigned weights, and a formula may be applied to calculate the reputation. For example, a user's history and frequency of interaction with the network-based publisher 102 may be accorded more weight because a long-time or frequent user of the network-based publisher 102 is inherently more trustworthy than a first-time user of the network-based publisher 102. Further, depending on the role of the user, different pieces of aggregated data may be selected for inclusion in the calculation of the user's reputation score. For example, if the user is a seller, certain aggregated data pertaining to the user's role as a seller may be selected and weighted as part of the reputation value calculation. Examples of aggregated data to be included in a seller reputation value calculation may include, but are not limited to, seller feedback, metadata concerning the user's shipping timeliness, the number of transactions conducted by the user as a seller, and the number of items listed for sale by the user. One of skill in the art will appreciate that if a reputation value is to be generated for the user for his role as a buyer, different pieces of data may be selected and weighted. It is to be appreciated that not every piece of aggregated data needs to be included in the reputation value calculation; rather, relevant subsets of aggregated data may be used in the calculation.

The reputation for a user may be exposed by the network-based publisher 102 or one of its components to a third party website or server via an API. In this respect, third party websites may use the reputation score or value maintained by the network-based publisher 102 to verify the veracity or trustworthiness of a user on the third party site.

In an example embodiment, an analytical sub-module (not shown) of the tracking module 214 may examine a user's value to the business of the network-based publisher 102. If the user's behavior indicates that the user is a valuable member of the network-based publisher 102 (e.g., the user transacts a large amount of business on the network-based publisher 102), the reputation module 220 may adjust the reputation score of the user to factor in the user's business value.

A claims module 222 may store claims made by or against a user. A claim may be a record that identifies an issue or problem with an aspect of a transaction. A claim may be filed by a seller or a buyer. Example embodiments in which a seller may file a claim against a buyer may include the failure of a buyer to pay for an item or a fraudulent payment submitted by a buyer for an item. Example embodiments in which a buyer may file a claim against a seller may include the failure of a seller to ship an item, the delivery of an item that does not match the item's description, damage incurred to an item shipped to a buyer, and an untimely shipped item.

Claims filed against a user may adversely affect a reputation score of the user, as the presence of claims may indicate a degree of untrustworthiness of a user. However, in certain circumstances, a first party may maliciously attempt to affect a second party's reputation score through the submission of multiple fraudulent claims against the counterparty. In these circumstances, the reputation module 220 may analyze the claims filed against the second party to determine if the multiple claims are being filed by only one party. If so, the reputation module 220 may examine the trustworthiness of the first party who is filing the claims. For example, the reputation module 220 may consider whether the first party is a potential competitor of the second party, whether the first party holds a grudge against the second party, and so forth. These considerations may be inferred based on the items sold by each party, feedback left by the first party for the second party that may indicate a source of tension between the two parties over a disputed transaction, and so forth. If a determination is made that claims are being maliciously filed against a particular user, the reputation module 220 may disregard the maliciously filed claims when calculating a user's reputation score or may compensate the reputation score of the user to account for the maliciously filed claims.

A similar adjustment may be implemented for a user's reputation score in the event the reputation module 220 determines that negative feedback is being maliciously submitted for a particular user. If the bulk of feedback for a user (e.g., seller) is originating from a particular user (e.g., buyer), the reputation module 220 may examine the particular user to determine whether that user is trustworthy. For example, the reputation module 220 may examine the feedback history for the particular user (e.g., buyer) to determine if the particular user has a history of leaving negative feedback for a particular category of items. In other scenarios, the reputation module 220 may examine the particular user's history of revising feedback left for the user, or may examine the communications between the seller and the buyer. If it is determined that the particular user is not trustworthy or that the particular user is leaving negative feedback with malicious intent, the reputation module 220 may adjust or compensate the reputation score of the user to account for the malicious intent or untrustworthiness of the particular user.

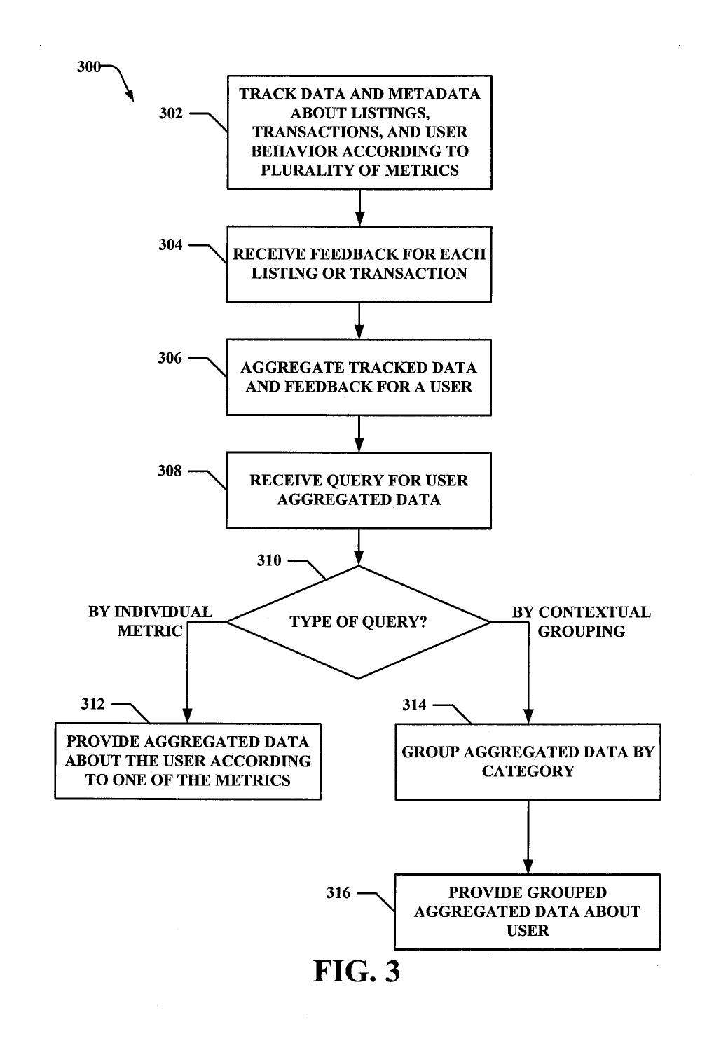

FIG. 3 is a flow chart illustrating an example embodiment for tracking, aggregating, and providing user reputation data. At operation 302, data concerning listings, transactions, and user behavior with respect to a network-based publisher 102 may be tracked and stored. In one example embodiment, the data is tagged according to one or more of a plurality of metrics or attributes, thereby generating metadata for the tracked data. In another example embodiment, the tracked data may be stored on a per user basis for ease of reference. At operation 304, the network-based publisher 102 may receive feedback data for a listing or in response to a transaction. In a transaction having two parties, the feedback data may be left by one counterparty for the other party. The feedback data may consist of a set of user-selected answers to predetermined questions regarding the counterparty's satisfaction with aspects of the transaction, such as payment, shipping, and condition of the item. The feedback data further may consist of comments left by the counterparty for the other party. The feedback data may be stored and associated with the user, the transaction, or both. In one example embodiment, metadata associated with the received feedback data may be tracked and stored as well.

At operation 306, the tracked data and metadata and the received feedback data for a user may be aggregated to yield a set of aggregated data. At operation 308, the network-based publisher 102 may receive a query to view an aspect of the user aggregated data set. At operation 310, the type of query may be determined. If the query seeks to view the aggregated data by a single metric, at operation 312, data from the aggregated data conforming to the requested metric may be sliced, isolated, or otherwise segregated and returned. In example embodiments, the isolated data may further be separated by sub-category, such as by time frame. The returned subset of data may be presented visually or textually to the user. The returned subset of data further may be presented anonymously, where applicable, such that any metadata identifying the source of the data may be hidden or stripped.

If the query seeks to view the aggregated data by contextual grouping, at operation 314, the aggregated data is grouped according to relevant category. The process of grouping aggregated data may use the associated metadata to identify which data should be included in which category. For example, in a scenario where the user is a seller and is attempting to identify a pattern among received negative feedback, the user may query the network-based publisher 102 to display all negative feedback. The aggregated feedback may be sliced to yield a subset of aggregated data relating to negative feedback. The returned negative feedback may then be categorized using associated metadata. In the example scenario discussed above, one category may be the shipping destination for an item sold by the user. In this case, using the metadata associated with the negative feedback, the feedback may be sub-divided by shipping destination. At operation 314, the grouped aggregated data may be presented to the user. Using the example scenario discussed above, the sub-division of aggregated data may reveal a concentration of negative feedback data when the user ships an item to a specific destination. The user thereby is able to determine that he needs to improve his level of service for items shipped to the specific destination.

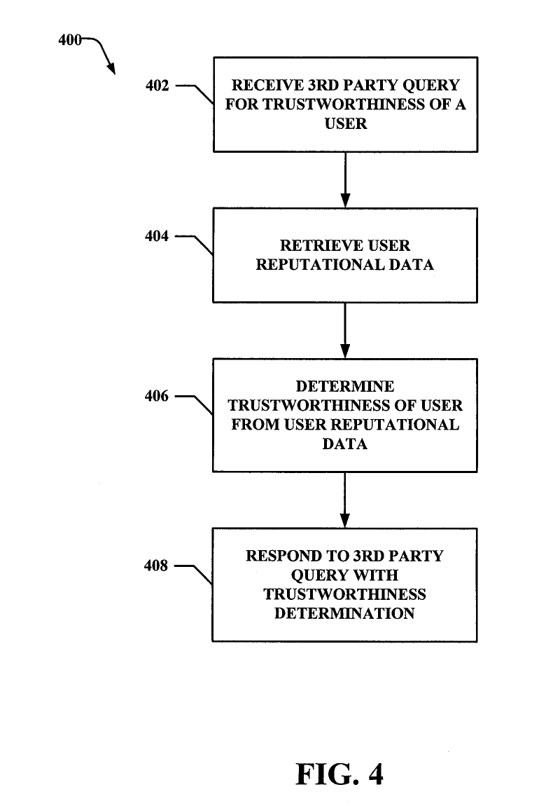

FIG. 4 is a flow chart illustrating an example method for determining and providing a trustworthiness determination of a user. The network-based publisher 102 may act on the aggregated data to generate a reputation value for a user. The reputation value, either standalone or when compared to a threshold, may indicate whether the user is trustworthy. The reputation value may be calculated according to a formula that weights various user attributes. The reputation value may be exposed by a network-based publisher API for use by third party applications and systems. At operation 402, the network-based publisher 102 receives a query from a third party, seeking to ascertain the trustworthiness of a user of the third party system. The third party may have been provided with an indication that the user of the third party system also is a user of the network-based publisher 102, or the third party may have no knowledge of whether the user is a user of the network-based publisher 102. In other words, the third party system simply may be conducting due diligence to determine the trustworthiness of one of its users.

At operation 404, in response to an API call to the network-based publisher 102 seeking to access user reputational data, the network-based publisher 102 may retrieve any reputational data, such as any or all of the aggregated feedback and tracked data, for the user.

At operation 406, if not already performed, the network-based publisher 102 may determine the trustworthiness of the user using the user reputational data. The trustworthiness of the user may coincide with a reputation score generated by the reputation application 208. Whether the user is considered trustworthy may depend on whether the user's reputation score is higher than a predetermined threshold for determining trustworthiness. Alternatively, the trustworthiness of the user may be determined by examining one or more pieces or categories of aggregated data. For example, the presence or absence of any negative feedback data may be examined to determine whether the user is trustworthy.

At operation 408, the network-based publisher 102 may respond to the third party API call with a trustworthiness determination. The determination may be a binary response, such as a “yes” or “no” response or a “trustworthy” or “untrustworthy” response, or, in one example embodiment, the network-based publisher 102 may return the generated reputation score for the user. The reputation score may be returned with a guide or threshold number indicating a minimum level of trustworthiness. The threshold thus serves to give context to the returned reputation score. Based on the returned response of how the network-based publisher 102 perceives the trust of the user, the third party system or application may make a determination of whether to trust the user.

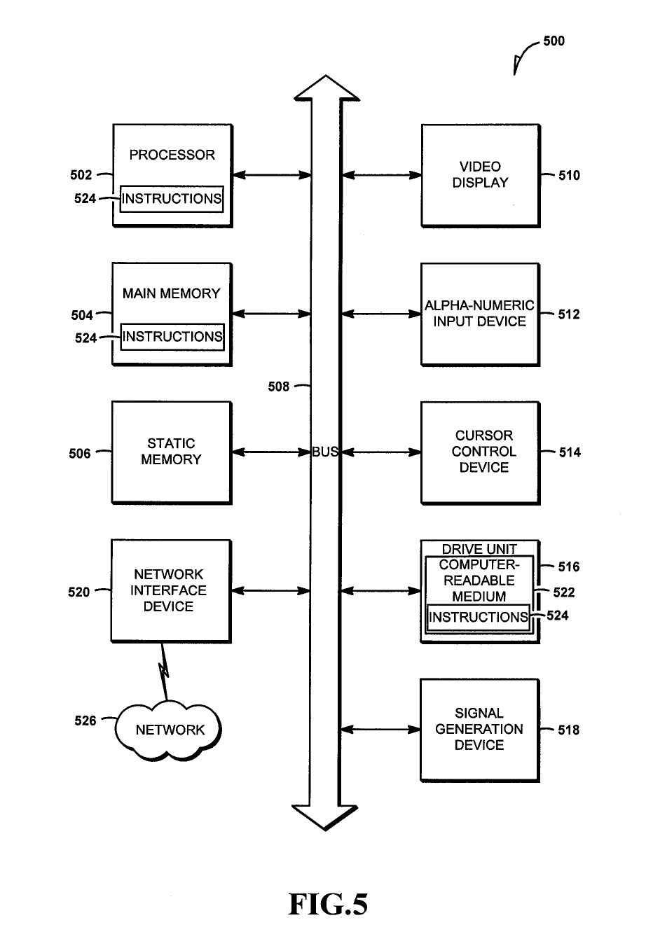

FIG. 5 shows a diagrammatic representation of machine in the example form of a computer system 500 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 220 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system, comprising:
a processor-implemented feedback module configured to receive feedback data in response to a transaction, the feedback data directed to a user of a network-based community involved in the transaction;
a processor-implemented tracking module configured to track and store data concerning the transaction and metadata associated with the transaction and the received feedback data;
a processor-implemented aggregation module configured to aggregate the received feedback data and the tracked data and metadata to yield an aggregated set of data, the aggregated set of data associated with the user; and
a processor-implemented reputation module configured to generate a reputation value for the user based on the aggregated set of user data, wherein the user is trustworthy if the user reputation value is greater than a predetermined threshold value, and wherein the user is not trustworthy if the user reputation value is not greater than the predetermined threshold value.

2. The system of claim 1, further comprising a processor-implemented query module configured to receive a query to analyze the aggregated set of data, the received query including one of a user attribute query and a contextual category query.

3. The system of claim 1, further comprising a processor-implemented claims module configured to store claim records relating to the user,
wherein the processor-implemented reputation module uses the claim records with the aggregated set of user data to generate the reputation value.

4. The system of claim 3, further comprising a processor-implemented analysis module configured to:
responsive to the user attribute query, provide to the user a first subset of data of the aggregated set of data having the user attribute specified in the user attribute query; and
responsive to the contextual category query,
categorize the aggregated set of data using the tracked metadata; and
provide to the user a second subset of data of the aggregated set of data conforming to a category specified in the contextual category query.

5. The system of claim 1, wherein the processor-implemented reputation module is further configured to provide the user reputation value to a third party system in response to an application programming interface (API) call received by the reputation module.

6. The system of claim 1, wherein the processor-implemented reputation module is further configured to:
receive an API call from a third party system seeking to determine the trustworthiness of the user;
generate, based on the user reputation value, a degree of trust determination; and
provide the degree of trust determination to the third party system as a response to the API call.

7. The system of claim 3, wherein the processor-implemented reputation module is further configured to adjust the user reputation value based on a determination that at least one of the feedback data and the claim records is one of maliciously submitted and submitted by an untrustworthy user.

8. The system of claim 1, wherein the user reputation value is calculated by applying a formula to a set of weighted user attributes.

9. The system of claim 8, wherein the weighted user attributes used in calculating the user reputation value are selected based on a role of the user in the network-based community.

10. A computer-implemented method, comprising:
receiving, at a networked system, feedback data pertaining to a user of a network-based community, the feedback data received in response to a transaction;
tracking, at the networked system, transaction data and metadata associated with the transaction data and the feedback data;
aggregating the feedback data and the tracked data and metadata to obtain an aggregated set of data;
generating, by a processor, a reputation value for the user from the aggregated set of data, wherein the reputation value indicates a trustworthiness of the user, wherein a user is trustworthy if the generated reputation value is greater than a predetermined threshold value, and wherein the user is not trustworthy if the generated reputation value is not greater than the predetermined value.

11. The computer-implemented method of claim 10, further comprising receiving a query from the user to analyze the aggregated set of data, the query specifying one of a user attribute and a contextual category to narrow the aggregated set of data.

12. The computer-implemented method of claim 11, further comprising:
responsive to a user attribute query:
searching the aggregated set of data using the user attribute; and
providing to the user a first subset of data of the aggregated set of data containing the user attribute; and
responsive to a contextual category query:
categorizing the aggregated set of data into categories using the tracked metadata; and
providing to the user a second subset of data of the aggregated set of data conforming to the contextual category specified in the query.

13. The computer-implemented method of claim 10, further comprising:
receiving an application programming interface (API) call from an external third party system, the API call requesting access to the reputation value of the user; and
providing the reputation value of the user to the third party system in response to the API call.

14. The computer-implemented method of claim 10, further comprising:
receiving an API call from an external third party system, the API call requesting a determination of trustworthiness of the user;
responsive to the API call, retrieving the reputation value of the user;
generating a trustworthiness determination based on the reputation value of the user; and
providing the trustworthiness determination to the external third party system as a response to the API call.

15. The computer-implemented method of claim 10, wherein the reputation value is generated by applying a formula to selectively weighted data and metadata of the aggregated set of results.

16. The computer-implemented method of claim 15, wherein the selectively weighted data and metadata of the aggregated set of results are selected based on a role of the user in the network-based community.

17. The computer-implemented method of claim 10, further comprising storing claim records relating to the user, wherein the reputation value of the user is generated from the claim records and the aggregated set of data.

18. The computer-implemented method of claim 17, further comprising adjusting the user reputation value based on a determination that at least one of the feedback data and the claim records is one of maliciously submitted and submitted by an untrustworthy user.

19. A non-transitory machine-readable storage medium storing a set of instructions that, when executed by a processor, causes the processor to perform operations, comprising:
receiving, at a networked system, feedback data pertaining to a user of a network-based community, the feedback data received in response to a transaction;
tracking, at the networked system, transaction data and metadata associated with the transaction data and the feedback data;
aggregating the feedback data and the tracked data and metadata to obtain an aggregated set of data;
generating a reputation value for the user from the aggregated set of data, wherein the reputation value indicates a trustworthiness of the user, wherein a user is trustworthy if the generated reputation value is greater than a predetermined threshold value, and wherein the user is not trustworthy if the generated reputation value is not greater than the predetermined value.

20. The non-transitory machine-readable storage medium of claim 19, further comprising receiving a query from the user to analyze the aggregated set of data, the query specifying one of a user attribute and a contextual category to narrow the aggregated set of data.

21. The non-transitory machine-readable storage medium of claim 20, further comprising:
responsive to a user attribute query:
searching the aggregated set of data using the user attribute; and
providing to the user a first subset of data of the aggregated set of data containing the user attribute; and
responsive to a contextual category query:
categorizing the aggregated set of data into categories using the tracked metadata; and
providing to the user a second subset of data of the aggregated set of data conforming to the contextual category specified in the query.

22. The non-transitory machine-readable storage medium of claim 19, further comprising:
receiving an application programming interface (API) call from an external third party system, the API call requesting access to the reputation value of the user; and
providing the reputation value of the user to the third party system in response to the API call.

23. The non-transitory machine-readable storage medium of claim 19, further comprising:
receiving an API call from an external third party system, the API call requesting a determination of trustworthiness of the user;
responsive to the API call, retrieving the reputation value of the user;
generating a trustworthiness determination based on the reputation value of the user; and
providing the trustworthiness determination to the external third party system as a response to the API call.

24. The non-transitory machine-readable storage medium of claim 19, wherein the reputation value is generated by applying a formula to selectively weighted data and metadata of the aggregated set of results, wherein the selectively weighted data and metadata of the aggregated set of results are selected based on a role of the user in the network-based community.

25. The non-transitory machine-readable storage medium of claim 19, further comprising storing claim records relating to the user, wherein the reputation value of the user is generated from the claim records and the aggregated set of data.

26. The non-transitory machine-readable storage medium of claim 25, further comprising adjusting the user reputation value based on a determination that at least one of the feedback data and the claim records is one of maliciously submitted and submitted by an untrustworthy user.
